(19) United States
(12) Patent Application Publication
(10) Pub. No.: US 2020/0099704 A1
(43) Pub. Date: Mar. 26, 2020

(54) METHOD AND APPARATUS FOR GENERATING SEMANTIC ATTACK GRAPH

(71) Applicant: ELECTRONICS AND TELECOMMUNICATIONS RESEARCH INSTITUTE, Daejeon (KR)

(72) Inventors: Joo Young LEE, Daejeon (KR); Ki Jong KOO, Daejeon (KR); Ik Kyun KIM, Daejeon (KR); Dae Sung MOON, Daejeon (KR); Kyung Min PARK, Daejeon (KR); Samuel WOO, Daejeon (KR); Ho HWANG, Daegu (KR)

(73) Assignee: ELECTRONICS AND TELECOMMUNICATIONS RESEARCH INSTITUTE, Daejeon (KR)

(21) Appl. No.: 16/578,511

(22) Filed: Sep. 23, 2019

(30) Foreign Application Priority Data
Sep. 21, 2018 (KR) 10-2018-0113508

(51) Int. Cl. H04L 29/06; H04L 12/24

(52) U.S. Cl. CPC H04L 63/1416; H04L 63/145; H04L 41/145; H04L 63/1466; H04L 63/1433

(57) ABSTRACT

Disclosed are a method and apparatus for searching for an attack path. The apparatus generates an attack graph, generates an attack graph ontology, generates a semantic attack graph by imparting semantics to the attack graph on the basis of the attack graph ontology, and searches for the attack path on the basis of the semantic attack graph.

### CROSS REFERENCE TO RELATED APPLICATION

The present application claims priority to Korean Patent Application No. 10-2018-0113508, filed Sep. 21, 2018, the entire contents of which is incorporated herein for all purposes by this reference.

### BACKGROUND OF THE INVENTION

### Field of the Invention

The present invention relates to a method of generating a semantic attack graph that enables a user to efficiently search for desired information from many identified possible attack paths when analyzing an attack surface of an organization.

### Description of the Related Art

An attack graph is a visualized representation of all attack paths that can be identified using asset information and a common vulnerabilities and exposures (CVE) database of an organization and which can be used by an attacker to reach an attack target system. In recent years, hackers have attacked their target system with careful scrutiny of the systems and systematic strategies. However, in many cases, organizations have failed to take appropriate actions against even known vulnerabilities due to the difficulty of managing a growing number of IT devices or have had difficulty in establishing a systematic defense strategy against security attacks. For example, many organizations are failing to understand and recognize the settings of their network and security environments.

An existing vulnerability scanning tool, which is one of the methods used to check the security of an organization, only can determine whether each host on a network has a vulnerability and provide a user with a vulnerability list consisting of the vulnerabilities. However, only with this checking, it is difficult for security personnel to determine effective counter measures when there are many hosts or vulnerabilities to be managed. On the other hand, attack graphs have advantages of enabling vulnerable hosts or threat vulnerabilities on an attack path to be identified and visualizing important elements on an attack path through topology analysis. Therefore, with the use of attack graphs, a user can take an efficient and optimized countermeasure to attacks.

A representative study of attack graphs was done by Sushil Jajodia and Steven Noel. It models exploit and security conditions (information available to attackers such as vulnerabilities) as a single node (vertex) and creates an attack graph in which dependencies among nodes are represented by lines (edges) on the basis of preconditions and postconditions for each node. In addition, attack paths were derived by expressing them as a sequence of security conditions. In addition, in order to calculate probabilistic values that indicate relative difficulty levels of attacks for each stage on a path along which an attacker reaches the final destination by passing through vulnerable systems one after another, Bayesian network or Markov modeling is used.

As mentioned earlier, the attack graph itself is useful for identification of an organization's security exposure point because it presents the probability of an event that an attacker can reach its destination on the basis of analysis of vulnerabilities existing in a network host and topology analysis. However, even on a network composed of few hosts, there are numerous possible attack paths and a large-scale attack graph is generated. Therefore, it is difficult to obtain detailed information required for a more effective response although it is possible to obtain intuitive information that can be obtained from a visualized graph.

### SUMMARY

An objective of the present invention is to provide an apparatus and method for providing a user with a large-scale attack graph by imparting semantics to an attack graph.

Another objective of the present invention is to provide a method and apparatus for generating a semantic attack graph for helping a user to identify a security vulnerability.

The present invention aims at providing intuitive information on a relationship between a host and a vulnerability by identifying and visualizing all possible attack paths.

The present invention aims at efficiently analyzing an attack surface of an organization.

A further objective of the present invention is to provide a semantic search method using a large-scale attack graph, thereby helping a user to obtain desired detailed information.

The present invention aims at enhancing security of a system by establishing an effective countermeasure against an attack.

The technical problems to be solved by the present invention are not limited to the ones mentioned above, and other technical problems which are not mentioned can be clearly understood by those skilled in the art from the following description.

According to one embodiment of the present invention, there is provided a method of searching for an attack path. The method may include generating an attack graph using information and generating an attack graph ontology for the attack graph.

In this case, a semantic attack graph may be generated by imparting semantics to an attack graph on the basis of the attack graph and the attack graph ontology.

According to one embodiment of the present invention, there is provided an apparatus for searching for an attack path. The apparatus may include an attack graph generation unit configured to generate an attack graph using information, an attack graph ontology construction unit configured to generate an attack graph ontology for the attack graph, and an attack graph semantic instance generation unit.

The attack graph semantic instance generation unit may generate a semantic attack graph by imparting semantics to an attack graph on the basis of the attack graph and the attack graph ontology and may search for an attack path on the basis of the generated semantic attack graph.

Embodiments described below may be applied to both the attack path searching method and apparatus.

According to one embodiment of the present invention, an attack graph semantic instance generation unit may generate an instance of the semantic attack graph.

According to one embodiment of the present invention, an inference engine may generate an attack path for the instance of the semantic attack graph and search for an attack path.

According to one embodiment of the present invention, attack path searching may be performed on the basis of the generated attack path.

According to one embodiment of the present invention, when the attack graph generation unit generates an attack graph, a state node is configured in the attack graph, and the state node is configured with status information and vulnerability information of a host.

According to one embodiment of the present invention, when the attack graph generation unit generates an attack graph, a network path between two hosts in the attack graph may be generated.

According to one embodiment of the present invention, when the attack graph generation unit generates the attack graph, the attack graph generation unit receives, as an input, a network reachability between two hosts, determines whether an attack is to occur on the basis of a vulnerability, and generates the attack path.

According to one embodiment of the present invention, the information may include at least one type of information selected from among host information, network information, topology information, and common vulnerabilities and exposures (CVE).

According to one embodiment of the present invention, the attack graph ontology construction unit may standardize a relationship between two nodes with a property and impart a property to an edge connected between nodes.

According to one embodiment of the present invention, the properties include a subject, a predicate, and an object.

The present invention can provide an apparatus and method for generating a large-scale attack graph to which semantics is imparted and from which a user can search for desired information.

The present invention can provide a method and apparatus for generating a semantic attack graph for helping a user to identify a security vulnerability.

The present invention can identify and visualize all possible attack paths, thereby providing a user with intuitive information based on a relationship between a host and a vulnerability.

The present invention has an advantage of effectively identifying an attack surface of an organization.

In addition, the present invention enables a semantic search can be performed on a large-scale attack graph unlike a conventional attack graph. Therefore, a user can obtain desired detailed information from the attack graph, thus being able to take an effective countermeasure to an attack. That is, the present invention has an advantage of enhancing a system security.

The effects and advantages that can be achieved by the present invention are not limited to the ones mentioned above, and other effects and advantages which are not mentioned above but can be achieved by the present invention can be clearly understood by those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating the configuration of an apparatus and method according to one embodiment of the present invention;

FIG. 2 is a diagram illustrating an exemplary procedure in which an attack graph generation unit generates nodes required for generation of an attack graph;

FIG. 3 is a diagram illustrating a procedure in which the attack graph generation unit calculates a reachability between two hosts through a network;

FIG. 4 is a step in which the attack graph generation unit derives all possible attack paths between two hosts, which can be used by an attacker;

FIG. 5 is a diagram a process in which an attack graph ontology construction unit imparts semantics between state nodes, according to one embodiment of the present invention;

FIG. 6 is a diagram illustrating a property representing a relationship between objects;

FIG. 7 is a diagram illustrating object attributes which are inferred;

FIG. 8 is an edge connected between nodes;

FIG. 9 is a diagram illustrating a semantic attack graph instance generated by an attack graph semantic instance generation unit according to one embodiment of the present invention;

FIG. 10 is a diagram illustrating a process in which an inference engine performs an inference search on a semantic attack graph instance, according to one embodiment of the present invention;

FIG. 11 is a diagram illustrating a process in which the inference engine performs an inference search on a semantic attack graph instance, according to one embodiment of the present invention; and

FIG. 12 is a flowchart illustrating an attack path searching method according to one embodiment of the present invention.

### DETAILED DESCRIPTION OF THE DISCLOSURE

Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe its invention in the best way possible.

The exemplary embodiments described herein and the configurations illustrated in the drawings are presented for illustrative purposes and do not exhaustively represent the technical spirit of the present invention. Accordingly, it should be appreciated that there will be various equivalents and modifications that can replace the exemplary embodiments and the configurations at the time at which the present application is filed.

The terminology used herein is for the purpose of describing particular embodiments only and is not intended to be limiting. As used herein, the singular forms “a”, “an” and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof.

Hereinbelow, exemplary embodiments of the present disclosure will be described in detail with reference to the accompanying drawings. In describing exemplary embodiments of the present invention, well-known functions or constructions will not be described in detail since they may unnecessarily obscure the understanding of the present invention. In addition, in describing the embodiments of the present invention, specific numerical values are merely examples.

With a method and apparatus for generating a semantic attack graph according to the present invention, it is possible to identify and visualize all possible attack paths, thereby providing a user with intuitive information on relations between hosts and vulnerabilities. Therefore, with the apparatus and the method, it is possible to effectively analyze an attack surface of an organization.

In addition, the present invention enables a semantic search to be performed on a large-scale attack graph unlike a conventional attack graph. Therefore, a user can obtain desired detailed information from the attack graph, thus being able to take an effective countermeasure to an attack. That is, present invention has an advantage of enhancing a system security.

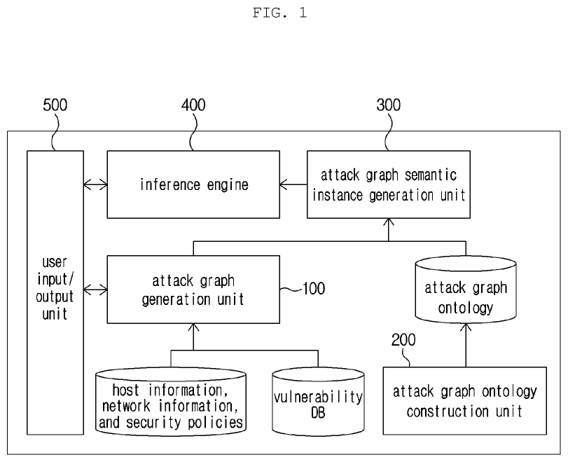

FIG. 1 is a diagram illustrating the configuration of an apparatus and method according to the present invention.

An apparatus for generating a semantic attack graph includes an attack graph generation unit 100, an attack graph ontology construction unit 200, an attack graph semantic instance generation unit 300, an inference engine 400, and a user input/output unit 500.

The attack graph generation unit 100 generates an attack graph by using one or more types of information selected from among host information, network topology information, security policy information, and common vulnerabilities and exposures (CVE).

The attack graph ontology construction unit 200 builds an ontology associated with an attack graph.

The attack graph semantic instance generation unit 300 imparts semantics to the attack graph that is generated on the basis of the attack graph ontology generated by the attack graph ontology construction unit 200.

The inference engine 400 performs an inference search on the semantic attack graph.

The user input/output unit 500 is a user interface helping the user to use the semantic attack graph generation apparatus. The user input/output unit 500 receives keywords to be searched as inputs and outputs the processing results of the input keywords.

The user input/output unit 500 visualizes and shows a query to a semantic attack graph generated by the semantic attack graph generation method and an answer to the query.

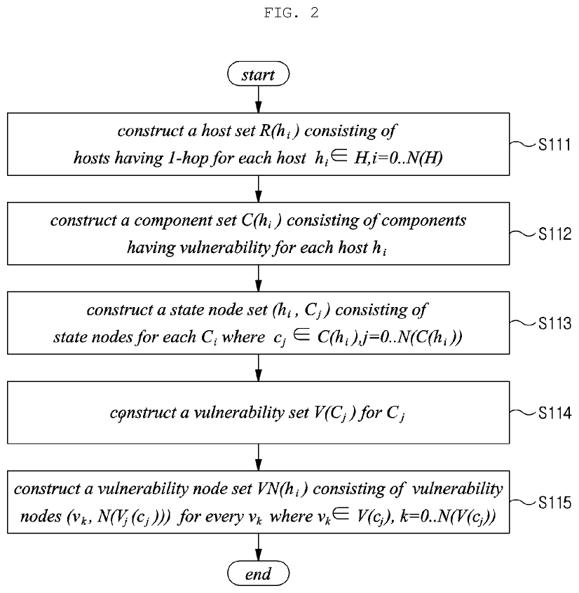

The attack graph generation unit 100 performs a node generation procedure 110 for configuring a state node using host status information and host vulnerability information, a network path generation procedure 120, and an attack path generation procedure 130 for generating a possible attack path on the basis of vulnerabilities. FIGS. 2, 3 and 4 are diagrams corresponding to the three functions performed by the attack graph generation unit 100.

FIG. 2 is a graph illustrating an exemplary procedure in which the attack graph generation unit 100 performs the node generation procedure 110 for generating an attack graph.

According to FIG. 2, the attack graph generation unit 100 generates a state node consisting of a component having a vulnerability, a host on which the component operates, and a vulnerability identifier.

More specifically, in order to configure a state node, a set of hosts is configured. To this end, according to one embodiment of the present invention, each host is defined as hᵢ and a set of hosts having a distance of one hop is defined as R(hᵢ) in which hᵢ∈H, i=0, . . . , N(H) in step S111.

A component having a vulnerability may be configured for each host in step S112. In this case, the component corresponds to an operating system, an application program, a service, or the like. A component set C(hᵢ), which is a set of components having a vulnerability, may be configured for each host hᵢ.

Thereafter, a state node composed of a vulnerable component and a host including the vulnerable component is generated in step S113. According to one embodiment of the present invention, a state node SN(hᵢ) for a vulnerable component Cⱼ (cⱼ∈C(hᵢ), j=0, . . . , N(C(hᵢ))) in each host is defined as (hᵢ, cⱼ).

One or more sets of vulnerabilities may be configured for one component. In step S114, according to one embodiment of the present invention, a set of vulnerabilities is defined as V(cⱼ). That is, a set of vulnerabilities is configured for a vulnerable component cⱼ.

Finally, vulnerability nodes, each consisting of the identifier of a representative vulnerability among the vulnerabilities in a vulnerability set and the number of elements in the vulnerability set, are generated in step S115.

Table 1 below shows examples of identifiers defined when the attack graph generation unit 100 generates nodes required for the attack graph.

TABLE 1

| identifier | definition |
|---|---|
| hᵢ | host |
| R(hᵢ) | set of hosts |
| | where hᵢ ϵ H, i = 0, . . . , N(H) |
| C(hᵢ) | set of vulnerable components in each host |
| SN(hᵢ) | set of state nodes (hᵢ, cⱼ) |
| | where cⱼ ϵ C(hᵢ), j = 0, . . . , N(C(hᵢ)) |
| V(cⱼ) | set of vulnerabilities of a vulnerable component cⱼ |
| VN(hᵢ) | set of vulnerability nodes (vₖ, N(V(cⱼ))) |
| | where vₖ ϵ V(cⱼ), K = 0, . . . , N(V(cⱼ)) |

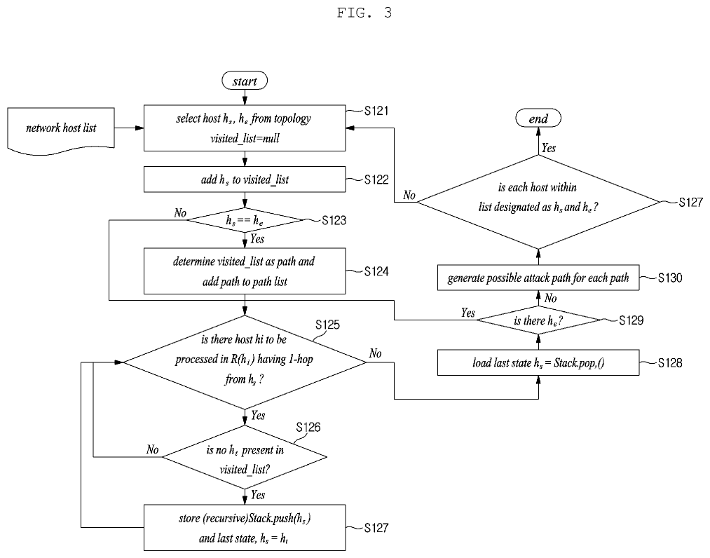

FIG. 3 is a diagram illustrating a procedure in which the attack graph generation unit 110 calculates a reachability between two hosts through a network.

The attack graph generation unit 100 calculates a network path. That is, the attack graph generation unit 100 calculates all reachable paths from one host to another. The calculation is performed for every host constituting a network.

Referring to FIG. 3, two hosts for which paths are not calculated are selected from the topology and designated as a starting host and an ending host, respectively in step S121, and the starting host is registered in a visit list in step S122. That is, the starting host hₛ and the ending host hₑ are selected from the topology, and the starting host hₛ is registered in the visit list Visited list.

Next, it is determined whether the starting host hₛ and the ending host hₑ are the same or not in step S123. When the starting host hₛ and the ending host hₑ are the same, the visit list is determined to have only one path and the path is added to a path list that includes paths between two hosts in step S124.

Next, it is checked whether there is a target host hₜ that can be reached with one hop from a starting host hₛ in step S125. When there is a target host hₜ that can be reached with one hop from a starting host hₛ, and when the target host hₜ is not present in the visit list in step S126, information on the current starting host and the processing status are stored in a stack. In addition, the target host hₜ is set as the next starting host in step S127. The path searching steps S125 to S127 are recursively performed.

That is, it is checked whether there is a target host hₜ that can be reached with one hop from a starting host hₛ in step S125. When it is determined that there is a target host hₜ that can be reached with one hop from a starting host hₛ, the information on the starting host and the processing status, which are stored in the stack, are read out in step s128. The path searching steps are repeated until the stack becomes empty to find all paths between the two hosts in step S129.

When all reachable paths between the two hosts are identified, an attack path along which an attack can be made is generated in step S130. Whether every host has been determined sequentially as the starting host and the ending host is checked. When the determination is affirmative, the above procedure ends.

Table 2 show examples of identifiers used in the procedure 120 in which the attack graph generation unit 100 calculates a reachability between two hosts through a network.

TABLE 2

| identifier | definition |
|---|---|
| hₛ | starting host |
| hₑ | ending host |
| Visited_list | visit list |
| hₜ | target host |

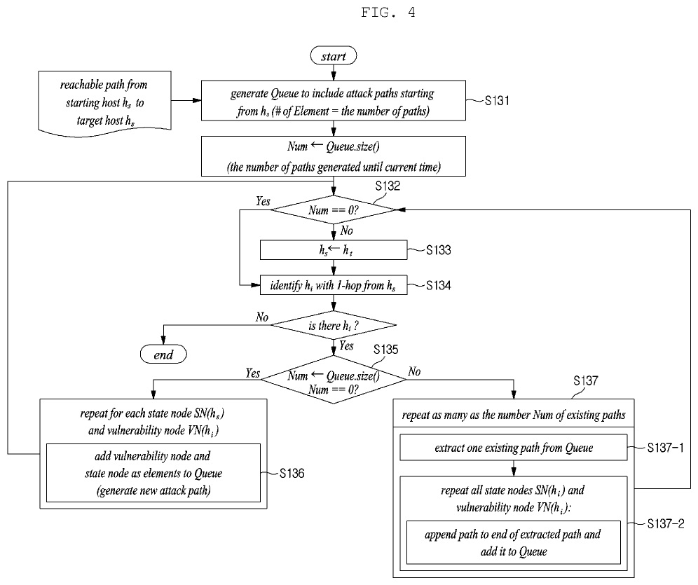

FIG. 4 is a diagram illustrating a step in which the attack graph generation unit 100 derives all possible attack paths between two hosts, which can be used by an attacker.

The attack graph generation unit 100 has a function of generating possible attack paths on the basis of vulnerabilities. More specifically, the attack graph generation unit 100 receives, as inputs, all reachability between two hosts through a network, identifies a vulnerability and a component with which an attack can be made, and generates a possible attack path using the identified vulnerability and component.

To this end, a queue including possible attack paths via which an attack from a starting host can be made is generated in step S131. Each element in the queue represents one possible attack path.

Starting with the first host on a network path in step S132, the next host is set as the target host in step S134. When there is no path created yet, all the state nodes of the target host are added to the queue one after another in step S136.

Next, the existing target host is set as the starting host in step S133. Next, the host next to the starting host on the network path is set as the target host in step S134. More specifically, a host which is positioned a distance of one hop from the starting host is set as the target host.

Next, it is checked whether the number of previously created paths is one or more in step S135. When there are one or more existing paths, one existing path is extracted from the queue in step S137-1. Next, a process of adding each state node to the queue is performed in step S137-2 in a manner that the state node of the target host is added to the end of the existing path.

In addition, the path is extended by repeatedly performing the step S137 for the existing path, thereby forming a new path. After all the state nodes are listed, each element in the queue is determined to be a possible attack path between two hosts.

When this process is repeatedly performed between every two hosts on the network path, it is possible to finally create all possible attack paths between the first host and the last host by using the vulnerabilities.

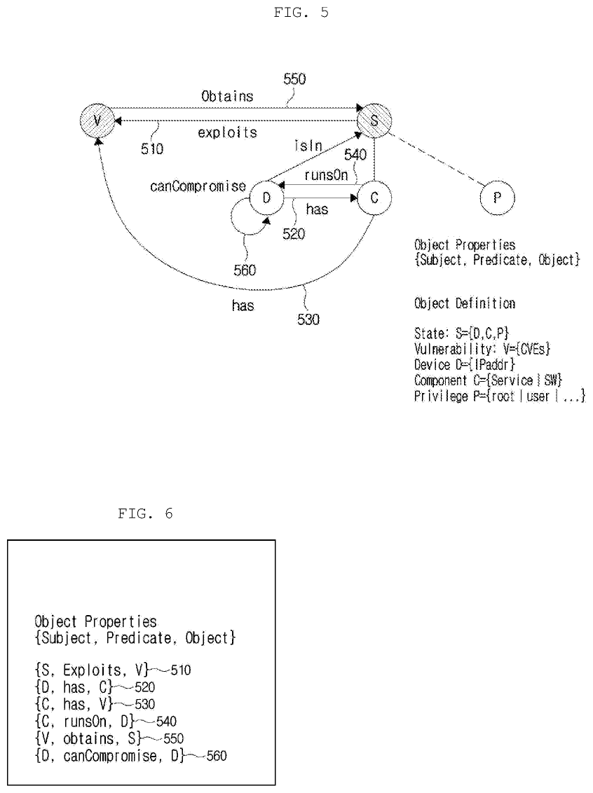

FIG. 5 is a diagram illustrating a process in which an attack graph ontology construction unit imparts semantics between state nodes, according to one embodiment of the present invention. The attack graph ontology construction unit 200 defines objects that constitute an attack graph node, and builds an ontology by standardizing a relationship between nodes with a property and by providing a property to an edge between the nodes.

FIG. 5 is a diagram illustrating an example of a semantic relationship between constituent objects in a semantic attack graph.

According to one embodiment of the present invention, the object properties include a subject, a predicate, an object, and the like. The subject means the subject of an action; the predicate defines the action of the subject and the relationship between the subject and the object; and the object corresponds to a configuration on which the action of the subject is performed.

The objects of the attack graph include a state node, a vulnerability node, a host device which is an element of the state node, a component including a service and a piece of software, and a component privilege. According to one embodiment of the present invention, an object may be defined as shown in Table 3 below.

TABLE 3

| object | definition |
|---|---|
| state node | S = {D, C, P} |
| vulnerability node | V = {CVEs} |
| host device | D = {IPaddr} |
| component | C = {Service\|SW} |
| privilege | P = {root\|user\| . . .} |

The predicates of the properties include words expressing a relationship between objects. According to one embodiment of the present invention, examples of the predicate include exploit, has, runs on, obtains, and can compromise. However, the predicates are not limited the above examples. The semantics of an edge between nodes can be expressed with the properties. For example, object properties may be expressed as {Subject, Predicate, Object}. According to one embodiment of the present invention, the attack graph ontology construction unit 200 uses the properties defined above. However, in addition to the objects and predicates defined above, an extended form of objects and properties can be defined and constructed depending on an operation method of the present invention. In this case, the construction result is provided as data or a file in a form that can be utilized by the attack graph instance generation unit 300 and the semantic inference engine 400.

Referring to FIG. 5, according to one embodiment of the present invention, the state S, the vulnerability V, the device D, the component C, and the privilege P are defined as objects. The properties representing the relationships between the objects are expressed as shown in FIG. 6.

In more detail, reference numeral 510 denotes object properties “{S, Exploits, V}” of FIG. 6. That is, it represents the relationship between the state node S and the vulnerability V. That is, it is defined such that the state node S exploits the vulnerability V.

Reference numerals 520 and 540 represent relationships between the device D and the component C. Reference numeral 520 in FIGS. 5 and 6 denotes {D, has, C} which is defined such that a host device D has a component C. In addition, Reference numeral 540 in FIGS. 5 and 6 denotes {C, runsOn, D} which is defined such that a component C is runs on a host device D.

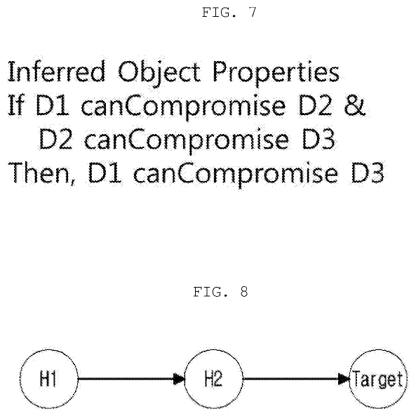

Object attributes can be inferred from the attack graph given such semantics. For example, the inferred object properties are expressed as shown in FIG. 7. In other words, when a second device D2 can be damaged by a first device D1 and a third device D3 can be damaged by the second device D2, an idea that the third device D3 can be damaged by the first device D1 can be inferred.

In the present invention, the semantic attack graph refers to an attack graph to which semantics are given.

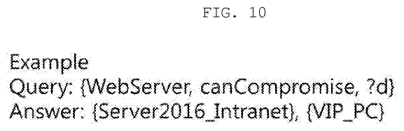

FIG. 9 is a diagram illustrating a semantic attack graph instance generated by an attack graph semantic instance generation unit according to one embodiment of the present invention.

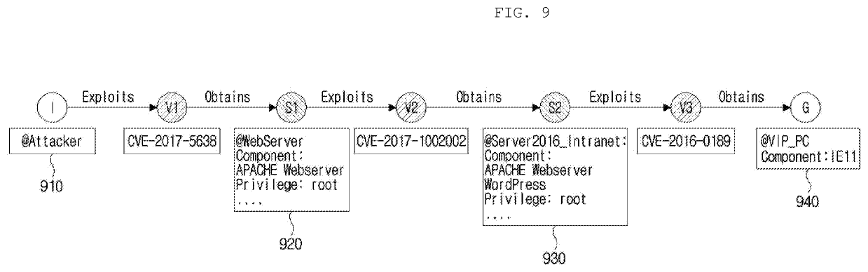

In the attack graph generated by the attack graph generation unit 100, a state node on a path provides information on vulnerabilities that can be exploited by an attacker and on components having the vulnerabilities. As illustrated in FIG. 8, an edge between nodes simply shows the next path.

However, referring to FIG. 9, in the semantic attack graph instance according to an embodiment of the present invention, it is confirmed that semantics between objects is given.

The attack graph semantic instance generation unit 300 generates a state node, a vulnerability node, device information, component information, and the like as object instances according to the ontology built by the attack graph ontology construction unit 200.

In addition, the attack graph semantic instance generation unit 300 generates a label of the edge between nodes according to the property.

The instance generated by the attack graph semantic instance generation unit 300 is provided as data or a file in a form that can be utilized by the inference engine 400.

An example of the created instance is shown in FIG. 9. Referring to FIG. 9, a path from a starting point I to a target point G, of which semantics is defined, is shown. Reference numeral 910 denotes an identifier. That is, it is possible to create an attack path for a semantic attack from I (@Attacker) to G (@VIP_PC).

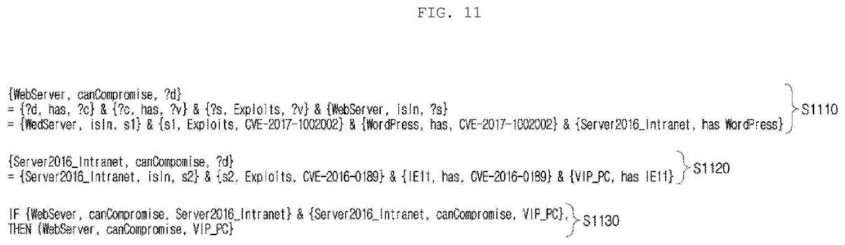

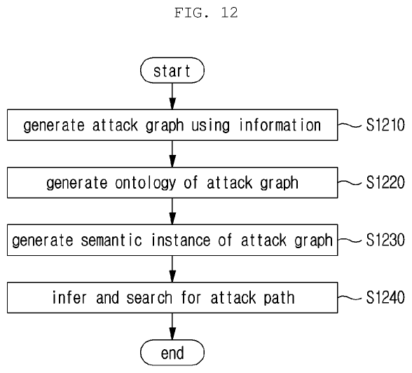

FIGS. 10 and 11 are diagrams illustrating a process in which an inference engine performs an inference search on semantic attack graph instances, according to one embodiment of the present invention.

The inference engine 400 provides a result of an inference search performed on the instantiated semantic attack graph. The inference engine 400 calculates a result suitable for a user query through a semantic inference process according to attributes of an object and characteristics such as transitive, symmetric, equivalent, inverseOf, etc. added to each property.

FIGS. 10 and 11 illustrate a user query to an instance of FIG. 9 and an answer to the user query, which results from the inference search process.

More specifically, FIGS. 9 and 10 illustrate examples of queries and answers according to one embodiment of the present invention. That is, in order to check which device ?D can be attacked by a webserver 920, the query “{WebServer, canCompromise, ?D}” is input in compliance with the property format. In this case, the present invention outputs “{Server2016_Intranet}” 930 and “{VIP_PC}” 940 as the results by performing an inference search process.

FIG. 11 is a diagram illustrating a detailed inference search process to obtain the results shown in FIG. 10 according to an embodiment of the present invention. When the query “which device ?D can be attacked by the webserver 920” is input, the answer “Server2016_Intranet” 930 is output through the processing process. This process corresponds to S1110.

S1120 is a process for a case where the query “which device ?D can be attacked by the Server2016_Intranet” which is the result of the process S1110 is input. In this case, “VIP_PC” 940 is output as the answer to the query through the inference search process. That is, the device that can be attacked by the Server2016_Intranet is the VIP_PC.

Therefore, through step S1130 of FIGS. 9 and 11, when the WebServer 920 may damage the Server2016_Intranet 930 and the Server2016_Intranet 930 may damage the VIP_PC 940, an inference that the WebServer 920 may damage the VIP_PC 940 is obtained.

FIG. 12 is a flowchart illustrating a method of searching for an attack path, according to one embodiment of the present invention.

First, the attack graph generation unit 100 generates an attack graph using information in step S1210. Thereafter, the attack graph ontology construction unit 200 defines objects constituting the nodes of the attack graph and generates an attack graph ontology for the attack graph in step S1220.

The attack graph semantic instance generation unit 300 generates a semantic attack graph by imparting semantics to an attack graph on the basis of the attack graph and the attack graph ontology in step S1230.

Next, the inference engine 400 searches for an attack path from the generated semantic attack graph in step S1240.

With the method and apparatus for generating a semantic attack graph according to the present invention, when analyzing an attack surface, it is possible to generate a semantic attack graph showing large-scale possible attack paths, from which information desired by a user can be effectively searched for.

The advantages and features of the present invention and the manner of achieving them will become apparent with reference to the embodiments described in detail below and the accompanying drawings. The present invention may, however, be embodied in many different forms and should not be construed as being limited to the embodiments set forth herein. Rather, these embodiments are provided so that the present invention will be thorough and complete and will fully convey the concept of the invention to those skilled in the art. Thus, the present invention will be defined only by the scope of the appended claims.

What is claimed is:

1. A method of searching for an attack path, the method comprising:
generating an attack graph by using information;
generating an attack graph ontology for the attack graph;
generating a semantic attack graph by imparting semantics to the attack graph on the basis of the attack graph and the attack graph ontology; and
searching for an attack path from the semantic attack graph.

2. The method according to claim 1, wherein the searching for the attack path comprises:
generating an instance of the semantic attack graph; and
generating an attack path for the instance of the semantic attack graph.

3. The method according to claim 2, wherein the searching for the attack path is performed on the basis of the generated attack path.

4. The method according to claim 1, wherein the generating of the attack graph comprises configuring a state node in the attack graph, in which the state node includes status information and vulnerability information of a host.

5. The method according to claim 1, wherein the generating of the attack graph comprises generating a network path between two hosts in the attack graph.

6. The method according to claim 1, wherein the generating of the attack graph comprises:
receiving, as an input, a network reachability between two hosts,
determining whether an attack is to occur on the basis of a vulnerability, and
generating the attack path.

7. The method according to claim 1, wherein the information includes at least one of information selected from among host information, network topology information, security policy information, and common vulnerabilities and exposures (CVE).

8. The method according to claim 1, wherein the generating the attack graph ontology comprises:
specifying a relationship between two nodes in the attack graph to a property, and
imparting the property to an edge connected between the two nodes.

9. The method according to claim 8, wherein the property includes at least one of a subject, a predicate, and an object.

10. An apparatus for searching for an attack path, the apparatus comprising:
an attack graph generation unit configured to generate an attack graph using information;
an attack graph ontology construction unit configured to generate an attack graph ontology for the attack graph; and
an attack graph semantic instance generation unit,
wherein the attack graph semantic instance generation unit generates a semantic attack graph by imparting semantics to the attack graph on the basis of the attack graph and the attack graph ontology, and searches for an attack path from the generated semantic attack graph.

11. The apparatus according to claim 10, wherein the attack graph semantic instance generation unit generates an instance of the generated semantic attack graph.

12. The method according to claim 11, further comprising an inference engine configured to generate the attack path for the instance of the semantic attack graph and search for the attack path.

13. The apparatus according to claim 12, wherein the attack graph semantic instance generation unit is configured to search for the attack on the basis of the generated attack path.

14. The apparatus according to claim 10, wherein when the attack graph generation unit generates the attack graph, a state node is configured in the attack graph in which the state node is configured with state information and vulnerability information of a host.

15. The apparatus according to claim 10, wherein when the attack graph generation unit generates the attack graph, a network path between two hosts in the attack graph is generated.

16. The apparatus according to claim 10, wherein when the attack graph generation unit generates the attack graph, the attack graph generation unit receives, as an input, a network reachability between two hosts, determines whether an attack is to occur on the basis of a vulnerability, and generates the attack path.

17. The apparatus according to claim 10, wherein the information includes at least one of information selected from among host information, network topology information, security policy information, and common vulnerabilities and exposures (CVE).

18. The apparatus according to claim 10, wherein a relationship between two nodes in the attack graph is standardized with a property, and the property is imparted to an edge connected between the two nodes.

19. The apparatus according to claim 18, wherein the property includes at least one of a subject, a predicate, and an object.
